(19) United States
(12) Patent Application Publication
(10) Pub. No.: US 2015/0258537 A1
(43) Pub. Date: Sep. 17, 2015

(54) EXHAUST GAS PURIFYING CATALYST

(71) Applicant: TOYOTA JIDOSHA KABUSHIKI KAISHA, Toyota-shi (JP)

(72) Inventors: Kei MOROHOSHI, Toyota-shi (JP); Tatsuya MIYAZAKI, Susono-shi (JP)

(21) Appl. No.: 14/625,978

(22) Filed: Feb. 19, 2015

(30) Foreign Application Priority Data
Mar. 14, 2014 (JP) 2014-051563

(51) Int. Cl. B01J 35/02; B01D 53/94; B01J 21/04; B01J 29/85; B01J 21/06

(52) U.S. Cl. CPC B01J 35/023; B01J 29/85; B01J 21/066; B01J 21/04; B01D 53/9418; B01D 2255/50; B01D 2255/20715; B01D 2255/2092

(57) ABSTRACT

To provide an exhaust as purifying catalyst where the NO purification ratio at a high temperature is improved. An exhaust gas purifying catalyst containing copper ion-exchanged zeolite having supported thereon zirconium oxide with a crystallite diameter of 39.1 nm or less is provided.

### TECHNICAL FIELD

The present invention relates to an exhaust gas purifying catalyst capable of selectively reducing nitrogen oxide (NOₓ) in an exhaust gas containing oxygen (O₂).

### BACKGROUND ART

An exhaust gas from a vehicle, for example, an automobile, contains carbon monoxide (CO), hydrocarbon (HC), nitrogen oxide (NOₓ), a particulate matter (PM), etc., as well as water and carbon dioxide which are produced by combustion of a fuel such as gasoline. The nitrogen oxide becomes a cause of environmental contamination, for example, air pollution, photochemical smog or acid rain, and therefore its emission is regulated by automobile exhaust gas regulations, etc.

As the technique for reducing nitrogen oxide in an exhaust gas, a method of reacting nitrogen oxide with a reducing agent such as ammonia by using an exhaust gas purifying catalyst to reduce nitrogen oxide (NOₓ) to nitrogen (N₂) and water (H₂O) is known.

The method of selectively reducing nitrogen oxide (NO₂) to nitrogen (Nₓ) and water (H₂O) in an exhaust gas containing oxygen (O₂) by using an exhaust gas purifying catalyst is called a selective catalytic reduction method, i.e., SCR (Selective Catalytic Reduction) method. The exhaust gas purifying catalyst for use in the SCR method is also called a selective reducing catalyst.

As such an exhaust gas purifying catalyst, for example, a catalyst having zeolite in which a copper (Cu) element is ion-exchanged, that is, a copper ion-exchanged zeolite, is known.

For example, in Patent Document 1, with regard to selective reduction of nitrogen oxide contained in an exhaust gas of a diesel engine, an exhaust gas purifying catalyst having zeolite containing from 1 to 10 mass % of copper, on which a homogeneous cerium-zirconium mixed oxide and/or cerium oxide are supported, is disclosed.

In many cases, an exhaust gas purifying catalyst is generally coated on a base material, such as honeycomb or filter, and is provided in an exhaust gas flow path.

### RELATED ART

### Patent Document

Patent Document 1 Japanese Unexamined Patent Publication No. 2011-121055

### SUMMARY OF THE INVENTION

### Problems to be Solved by the Invention

The above-described conventional exhaust gas purifying catalyst containing copper ion-exchanged zeolite having supported thereon zirconium oxide sometimes decreases in the activity at a high temperature, for example, 500° C. or more. In addition, after the conventional exhaust gas purifying catalyst containing copper ion-exchanged zeolite having supported thereon cerium oxide is coated on the surface of a base material, the catalyst is sometimes separated from the base material surface at the time of firing and/or use.

The present invention provides an exhaust gas purifying catalyst where the NOₓ purification ratio at a high temperature is improved, compared with the conventional exhaust gas purifying catalyst containing copper ion-exchanged zeolite having supported thereon zirconium oxide.

The present invention also provides an exhaust gas purifying catalyst where when the catalyst is coated on the surface of a base material, the separation ratio is reduced, compared with the conventional exhaust gas purifying catalyst containing copper ion-exchanged zeolite having supported thereon cerium oxide.

### Means to Solve the Problems

The present invention solves the above-described problems, for example, by the following embodiments.

<1> An exhaust gas purifying catalyst containing copper ion-exchanged zeolite having supported thereon zirconium oxide with a crystallite diameter of 39.1 nm or less.

<2> The exhaust gas purifying catalyst according to item 1, wherein aluminum oxide is further supported on the copper ion-exchanged zeolite.

<3> An exhaust gas purifying method, comprising bringing an exhaust gas containing nitrogen oxide and ammonia into contact with the exhaust gas purifying catalyst according to item 1 or 2 to reduce the nitrogen oxide.

### Effects of the Invention

In the exhaust gas purifying catalyst of the present invention, the NOₓ purification ratio (%) at a high temperature, for example, 500° C. or more, is improved, compared with the conventional exhaust gas purifying catalyst containing copper ion-exchanged zeolite having supported thereon zirconium oxide.

Furthermore, in the exhaust gas purifying catalyst of the present invention described in item <2> above, when the catalyst is coated on the surface of a base material, the separation ratio (%) of the catalyst from the base material surface is reduced, compared with the conventional exhaust gas purifying catalyst containing copper ion-exchanged zeolite having supported thereon cerium oxide.

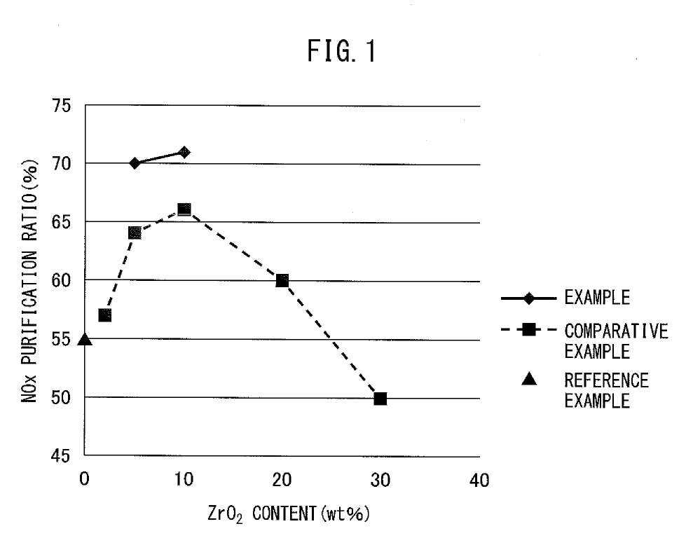

### BRIEF DESCRIPTION OF THE DRAWINGS

[FIG. 1] FIG. 1 is a graph illustrating the NOₓ purification ratio (%) at 600° C. of exhaust gas purification catalysts of Examples 1 and 2, Comparative Examples 1 to 5, and Reference Example 1.

### MODE FOR CARRYING OUT THE INVENTION

The exhaust gas purifying catalyst of the present invention contains copper ion-exchanged zeolite having supported thereon zirconium oxide with a crystallite diameter of 39.1 nm or less.

<<Zirconium Oxide>>

The upper limit of the crystallite diameter of zirconium oxide can be 39.1 nm or less, and the lower limit can be 0.1 nm or more, for example, 1 nm or more, 10 nm or more, 20 nm or more, or 30 nm or more.

In the exhaust gas purifying catalyst of the present invention containing copper ion-exchanged zeolite having supported thereon zirconium oxide with the above-described crystallite diameter, the NOₓ reduction ratio particularly at a high temperature, for example, 500° C. or more, 550° C. or more, or 600° C. or more, is improved, compared with the conventional exhaust gas purifying catalyst containing copper ion-exchanged zeolite having supported thereon zirconium oxide.

Without being bound by theory, it is considered that by setting the crystallite diameter of zirconium oxide to the range above, zirconium oxide can be homogeneously dispersed and supported on a particle of copper ion-exchanged zeolite, leading to improvement of the NOₓ reduction ratio of the exhaust gas purifying catalyst.

In the present invention, the crystallite diameter of zirconium oxide can be measured as follows in accordance with Japanese Industrial Standards JIS H7805. That is, an X-ray diffraction (XRD: X-ray Diffraction) pattern obtained by irradiating the sample with an X-ray is measured. From a strongest diffraction peak of zirconium oxide, typically, a peak around 2θ=about 28.2°, the crystallite diameter (nm) is calculated using the Scherrer equation representing the relationship between the broadening of diffraction line width and the crystallite diameter.

The upper limit of the content of zirconium oxide can be 25 mass % or less, for example, 20 mass % or less, 15 mass % or less, or 10 mass % or less, based on the total mass of zeolite. The lower limit can be 0.1 mass % or more, for example, 1 mass % or more, 2 mass % or more, 3 mass % or more, or 5 mass % or more, based on the total mass of zeolite.

<<Other Metal Oxides>>

On the copper ion-exchanged zeolite, in addition to zirconium oxide with a crystallite diameter of 39.1 nm or less, any other metal oxides, for example, cerium oxide, aluminum oxide, silicon dioxide, lanthanum oxide and vanadium oxide, can be further supported.

Particularly, when in addition to zirconium oxide with a crystallite diameter of 39.1 nm or less, aluminum oxide is further supported on copper ion-exchanged zeolite, the separation ratio of the exhaust gas purifying catalyst of the present invention is reduced, compared with the conventional exhaust gas purifying catalyst containing copper ion-exchanged zeolite having supported thereon cerium oxide.

Without being bound by theory, it is considered that by using zirconium oxide having a thermal expansion coefficient smaller than that of a metal oxide such as cerium oxide and setting the crystallite diameter of zirconium oxide to 39.1 nm or less, the adherence between the coating and the base material is improved, leading to reduction in the separation ratio.

The upper limit of the other metal oxide, e.g., aluminum oxide, can be 10 mass % or less, for example, 7 mass % or less, or 5 mass % or less, based on the total mass of zeolite. The lower limit can be 0.1 mass % or more, for example, 1 mass % or more, or 2 mass % or more, based on the total mass of zeolite.

<<Copper Ion-Exchanged Zeolite>>

Zeolite is also called boiling stone and is generally an aluminosilicate having a framework structure where elements such as silicon, oxygen and aluminum are bonded in a net-like manner. Zeolite also contains an any element cation, for example, hydrogen ion, alkali metal ion or alkaline earth metal ion, so as to compensate for the negative charge in the framework structure.

The zeolite for use in the present invention is copper ion-exchanged zeolite where any cations contained in such zeolite are at least partially exchanged with copper ion.

The framework structure of the copper ion-exchanged zeolite is not particularly limited and includes, for example, a chabazite type, an A-type, a Y-type, a β-type, and a ferrierite type.

The chabazite-type zeolite is zeolite generally having a three-dimensional pore structure containing an oxygen 8-membered ring and is zeolite having a structure code CHA as classified by the International Zeolite Association. The chabazite-type zeolite includes, for example, SAPO-34 and SSZ-13.

The upper limit of the content of copper contained in zeolite can be 10 mass % or less, for example, 5 mass % or less, or 3 mass % or less, and the lower limit can be 0.1 mass % or more, for example, 1 mass % or more, or 2 mass % or more.

<<Production Method>>

As the method for producing the exhaust gas purifying catalyst of the present invention, any method can be used as long as zirconium oxide with a crystallite diameter of 39.1 nm or less can be supported on copper ion-exchanged zeolite.

In such a method, for example, a solution containing an alkali source such as aqueous ammonia and a solution containing zirconium ion, e.g., a solution containing zirconium nitrate, are quickly mixed to obtain a dispersion solution containing zirconium with a crystallite diameter of 39.1 nm or less.

In the mixing above, for example, the solution containing zirconium ion is added to the solution containing an alkali source such as aqueous ammonia at a high addition rate, whereby many zirconium nuclei can be produced and zirconium with a crystallite diameter of 39.1 nm or less can be obtained by suppressing crystal growth. The order of addition is optional, and the solution containing an alkali source such as aqueous ammonia can be added to the solution containing zirconium ion.

The addition rate varies depending on the scale, etc. of the reaction used but, for example, in the case of production on a laboratory scale of from about 100 mL to about 1 L, the addition rate can be 350 mL/min or more, for example, 400 mL/min or more, 450 mL/min or more, or 500 mL/min or more.

Copper ion-exchanged zeolite is put in the obtained dispersion solution, and the mixture is stirred, dried and fired, whereby copper ion-exchanged zeolite having supported thereon zirconium oxide with a crystallite diameter of 39.1 nm or less can be produced.

In another method, for example, copper ion-exchanged zeolite is put in a dispersion solution containing zirconium oxide having a primary particle diameter of 39.1 nm or less, i.e., a crystallite diameter of 39.1 nm or less, and any other metal oxide particles, and impregnated with the solution under stirring, and the impregnated copper ion-exchanged zeolite is dried and fired, whereby copper ion-exchanged zeolite having supported thereon zirconium oxide with a crystallite diameter of 39.1 nm or less can be produced.

The drying and firing above can be performed after the impregnated copper ion-exchanged zeolite is coated on a base material.

The copper ion-exchanged zeolite having supported thereon zirconium oxide can be used by itself as the exhaust gas purifying catalyst of the present invention or can arbitrarily contain other additives such as binder.

### EXAMPLES

### Example 1

Ion-exchanged water containing zirconium nitrate was quickly added with stirring to ion-exchanged water containing aqueous ammonia at an addition rate of 500 mL/min by using a dropping funnel to produce a dispersion solution at a pH of 7 to 8 containing fine zirconium crystals. The amount of zirconium nitrate was adjusted such that the content of zirconium oxide finally becomes 5 mass % based on the total mass of zeolite.

SAPO-34 zeolite ion-exchanged with 3.0 mass % of copper was put in the obtained dispersion solution, and the mixture was stirred and heated to remove water to thereby obtain SAPO-34 zeolite where fine zirconium is dispersed and supported.

The obtained SAPO-34 zeolite was dried under heating at 120° C., and the solid matter after drying was pulverized in a mortar. The obtained powder was fired at 500° C. for 2 hours in the presence of oxygen and powder-compacted under a pressure of 1 ton to produce the pellet-shaped exhaust gas purifying catalyst of Example 1 having a particle diameter of 1.0 to 1.7 mm.

### Example 2 and Comparative Examples 1 to 5

Exhaust gas purifying catalysts of Example 2 and Comparative Examples 1 to 5 were produced by the same method as in Example 1 by changing the addition rate and the content of zirconium oxide as shown in Table 1.

### Reference Example 1

SAPO-34 zeolite ion-exchanged with 3.0 mass % of copper was fired at 500° C. for 2 hours in the presence of oxygen and powder-compacted under a pressure of 1 ton, and the obtained solid matter was pulverized to produce the exhaust gas purifying catalyst of Reference Example 1.

<<Crystallite Diameter>>

The samples of Example 2, Comparative Examples 1 to 5 and Reference Example 1 were measured for the X-ray diffraction peak, and the crystallite diameter of zirconium oxide was measured from a strongest diffraction peak of zirconium oxide at 2θ=about 28.2°. The results are shown in Table 1. Incidentally, in Example 1, since the addition rate is the same as in Example 2 and the concentration is lower than in the zirconium oxide dispersion solution of Example 2, the crystallite diameter of zirconium oxide in Example 1 is expected to be smaller than the crystallite diameter of zirconium oxide in Example 2.

<<NOₓ Purification Ratio>>

The exhaust gas purifying catalysts of Examples 1 and 2, Comparative Examples 1 to 5 and Reference Example 1 were measured for the NOx purification ratio as follows. That is, an inflow gas having a composition of 500 ppm of nitrogen monoxide, 500 ppm of ammonia, 10% of oxygen and 5% of water, with the balance being nitrogen, was contacted with 3 g of the pellet at a temperature of 600° C. and a flow velocity of 15 L/min, thereby performing a selective catalytic reduction reaction. The amount (ppm) of nitrogen monoxide in the inflow gas and the amount (ppm) of nitrogen monoxide in the outflow gas were measured, and the percentage decrease therebetween was defined as the NOₓ purification ratio (%). The results are shown in Table 1.

TABLE 1

| | Addition | | Crystallite | NOₓ Purification |
|---|---|---|---|---|
| | Rate | ZrO₂ Content | Diameter | Ratio at 600° C. |
| | (mL/min) | (mass %) | (nm) | (%) |
| Example 1 | 500 | 5 | — | 70 |
| Example 2 | 500 | 10 | 39.1 | 71 |
| Comparative | 100 | 2 | >100 | 57 |
| Example 1 | | | | |
| Comparative | 100 | 5 | >100 | 64 |
| Example 2 | | | | |
| Comparative | 100 | 10 | >100 | 66 |
| Example 3 | | | | |
| Comparative | 100 | 20 | >100 | 60 |
| Example 4 | | | | |
| Comparative | 100 | 30 | >100 | 50 |
| Example 5 | | | | |
| Reference | — | 0 | >100 | 55 |
| Example 1 | | | | |

The exhaust gas purifying catalysts of Examples 1 and 2 had a higher NOₓ reduction ratio at 600° C. than the exhaust gas purifying catalysts of Comparative Examples 1 to 5.

### Reference Examples 2 to 5 and Comparative Examples 6 to 8

In Reference Examples 2 to 5 and Comparative Examples 6 to 8, the exhaust gas purifying catalyst was coated on a honeycomb as a base material, and the separation ratio (%) of the catalyst was examined.

At least one of (1) a dispersion solution of commercially available aluminum oxide, (2) a dispersion solution of commercially available zirconium oxide having a nominal primary particle diameter of 40 nm, and (3) a dispersion solution of commercially available cerium oxide having a nominal primary particle diameter of 20 nm was mixed with ion-exchanged water to prepare a dispersion solution. Here, the amount of each of the dispersion solutions (1), (2) and (3) was adjusted such that the content (mass %) of the metal oxide finally becomes the amount shown in Table 2 below based on the total mass of zeolite. Incidentally, zirconium oxide having a nominal primary particle diameter of 40 nm is, in other words, zirconium oxide having a crystallite diameter of 40 nm or less.

SAPO-34 zeolite ion-exchanged with 3.0 mass % of copper was put in the mixed dispersion solution, and the resulting mixture was stirred and milled. The obtained dispersion solution was coated on a honeycomb base material having a diameter of 30 mm, a height of 50 mm and a number of cells of 400. Here, a base material dried at 250° C. for 1 hour before coating was used as the honeycomb base material. For the measurement of separation ratio, the mass W₀ (g) of the honeycomb base material after drying was recorded.

The honeycomb base material after coating was dried at 110° C. and fired at 500° C. for 2 hours to produce the exhaust gas purifying catalysts of Reference Examples 2 to 5 and Comparative Examples 6 to 8 where the catalyst is coated on a honeycomb base material.

<<Separation Ratio>>

Each of honeycomb substrates obtained was dried at 250° C. for 1 hour and measured for the mass W₁ (g) after drying. The honeycomb base material was cooled to room temperature and then exposed to an ultrasonic wave for 10 minutes in distilled water. The honeycomb base material was allowed to dry naturally and further dried at 250° C. for 1 hour, and the mass W₂ (g) of the honeycomb base material after drying was measured.

The ratio (%) of the weight (g) of the coating after exposure to an ultrasonic wave, to the weight (g) of the coating before exposure, that is, {(W₁−W₂)/(W₁−W₀)}×100, was defined as the separation ratio (%) of the catalyst. The results are shown in Table 2.

TABLE 2

| | Metal Oxide Content (mass %) | | | Separation |
|---|---|---|---|---|
| | Al₂O₃ | ZrO₂ | CeO₂ | Ratio (%) |
| Reference Example 2 | 0 | 7 | 0 | 3.52 |
| Reference Example 3 | 3 | 5 | 0 | 0.69 |
| Reference Example 4 | 5 | 2 | 0 | 0.80 |
| Comparative Example 6 | 0 | 0 | 7 | 4.62 |
| Comparative Example 7 | 3 | 0 | 5 | 2.25 |
| Comparative Example 8 | 5 | 0 | 2 | 1.96 |
| Reference Example 5 | 7 | 0 | 0 | 1.54 |

In Reference Examples 2 to 4, the separation ratio was improved, compared with corresponding Comparative Examples 6 to 8. In Reference Examples 3 and 4, the separation ratio was lower than in Reference Example 5 using only aluminum oxide, and this suggests that a combination use of zirconium oxide having a small crystallite diameter and aluminum oxide is effective in reducing the separation ratio of the catalyst.

1. An exhaust gas purifying catalyst containing copper ion-exchanged zeolite having supported thereon zirconium oxide with a crystallite diameter of 39.1 nm or less.

2. The exhaust gas purifying catalyst according to claim 1, wherein aluminum oxide is further supported on said copper ion-exchanged zeolite.

3. An exhaust gas purifying method, comprising bringing an exhaust gas containing nitrogen oxide and ammonia into contact with the exhaust gas purifying catalyst according to claim 1 to reduce the nitrogen oxide.

4. An exhaust gas purifying method, comprising bringing an exhaust gas containing nitrogen oxide and ammonia into contact with the exhaust gas purifying catalyst according to claim 2 to reduce the nitrogen oxide.
